(19) United States
(12) Patent Application Publication
(10) Pub. No.: US 2018/0050348 A1
(43) Pub. Date: Feb. 22, 2018

(54) QUENCH WATER HYDROCYCLONE

(71) Applicant: Mark Whitney, Houston, TX (US)

(72) Inventor: Mark Whitney, Houston, TX (US)

(21) Appl. No.: 15/241,099

(22) Filed: Aug. 19, 2016

(51) Int. Cl. B04C 9/00; C02F 1/38

(52) U.S. Cl. CPC B04C 9/00; C02F 2103/36; C02F 1/38

(57) ABSTRACT

An apparatus for processing liquid from a quench water tower includes a first pipe for removing the liquid from the quench water tower; a hydrocyclone in fluid communication with the first pipe and in which the liquid is separated into particulate and liquid constituents by centrifugal force; and an oil-water separator downstream of and in fluid communication with a first outlet of the hydrocyclone. A related system and method are also provided.

### BACKGROUND OF THE INVENTION

The present embodiments relate to chemical processing plants such as for example ethylene plants employing a light feed stock, wherein a quench water tower is used to cool furnace effluent and remove hydrocarbons having high boiling points.

Referring by way of example only to a known ethylene plant using a light feedstock, it is common practice to use a quench water tower 10 to cool furnace effluent 12 and remove hydrocarbons therein with high boiling points. In such an arrangement shown for example in FIG. 1, the incoming furnace effluent 12, after being cooled in heat exchangers (not shown), enters the quench water tower 10 where the gas is further cooled by direct contact with quench water. In the quench water tower 10, water contained in the furnace effluent is largely condensed. In addition, some high-boiling hydrocarbons are also condensed. Liquids 14 at a bottom 16 of the quench water tower 10 include the quench water and condensed water, with condensed hydrocarbons present therein. The liquid is separated, with approximately 95% being cooled and recycled to the quench water tower 10 as quench water. The remaining portion goes to an oil/water separator 18 (or separator 18) where the hydrocarbons are drawn off. The water from the separator goes to water processing 20 where the water is purified before being recycled into the process as a dilution stream or sent to waste water treatment. The furnace effluent 12 also contains a small quantity of solids, typically coke particles. These solids and heavy oils are removed in a stream 21 after settling in the separator 18.

The heavy oils and the solids must accumulate in the circulating quench water because only 4% to 5% of the liquid from the quench water tower 10 goes to the separator 18. Therefore, the concentration of the heavy oils and solids in the circulating quench water is 20 to 25 times the feed concentration to the quench water tower. This high concentration of solids and heavy hydrocarbons causes fouling in the quench water tower 10. The fouling reduces the tower performance and can causes premature shut-down of the plant for which the quench water tower 10 is associated.

Referring also to FIG. 2 and by way of example only to a known hydrocyclone 22 (also referred to herein as a “cyclone”), such is a device to separate particles in a liquid suspension based upon a ratio of the particles centripetal force to fluid resistance. This ratio is high for dense particles (where separation by density is required) and coarse particles (where separation by size is required), and low for light and fine particles. Hydrocyclones also find application in the separation of liquids having different densities. A hydrocyclone will usually be constructed with a cylindrical section 24 at the top into which a liquid 34, such as a waste stream, is fed tangentially through an inlet 26, and a conical base 30. The angle, and hence length, of the conical base 30 plays a role in determining operating characteristics of the hydrocyclone. A feed (of waste, for example) is introduced into the hydrocyclone through the inlet 26 such that cyclonic action of the cyclone produces a high density stream 38 and a low density stream 36.

Referring again to FIG. 1, a pump 40 is provided to deliver the liquids 14 from the bottom 16 of the quench water tower 10 to a heat exchanger 42 to cool the liquids prior to return of same to the quench water tower. As shown in FIG. 1, pipes or lines of known construction can connect the bottom 16 with the pump 40 and the separator 18, the pump 40 and the heat exchanger 2 with the quench water tower 10. A top 17 of the quench water tower 10 includes an ullage space 11 from which gases in the space can be removed, vented or exhausted from the quench tower for subsequent use such as for example to charge a gas compressor (not shown).

Heavy hydrocarbons contained in the quench water tower 10 can become solid at temperatures present in heat exchangers that cool the quench water. The solidified hydrocarbons reduce the ability of these heat exchangers to provide cooling, thereby reducing both plant efficiency and capacity. Fouling by such cooling in a conventional quench water system has been reported by operating companies.

The furnace effluent 12 also contains a small quantity of solids, typically coke particles. These solids and heavy oils are removed by settling out in the separator 18.

The heavy oils and the solids accumulate in the circulating quench water because only 4% to 5% of the liquid from the quench water tower 10 goes to the separator 18. Therefore, the concentration of the heavy oils and solids in the circulating quench water is 20 to 25 times the feed concentration to the quench tower. This high concentration of solids and heavy hydrocarbons causes fouling in the quench water tower 10. The fouling reduces the tower performance and can causes premature shut-down of the plant for which the quench water tower 10 is associated.

### SUMMARY OF THE INVENTION

There is therefore provided herein a system for processing liquid from a quench water tower, comprising a quench water tower; a first pipe for removing the liquid from the quench water tower; a hydrocyclone in fluid communication with the first pipe and in which the liquid is separated into particulate and liquid constituents by centrifugal force; and an oil-water separator downstream of and in fluid communication with a first outlet of the hydrocyclone.

There is also provided herein an apparatus downstream of and for processing liquid from a quench water tower, comprising a first pipe for removing the liquid from the quench water tower; a hydrocyclone in fluid communication with the first pipe and in which the liquid is separated into particulate and liquid constituents by centrifugal force; and an oil-water separator downstream of and in fluid communication with a first outlet of the hydrocyclone.

There is further provided herein a method of processing liquid from a quench water tower, comprising removing the liquid from the quench water tower; exerting a centrifugal force on the liquid with a hydrocyclone for separating said liquid into particulate and liquid constituents; and further separating the particulate and liquid constituents downstream of the exerting centrifugal force.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a schematic of a known quench water tower system to cool furnace effluent;

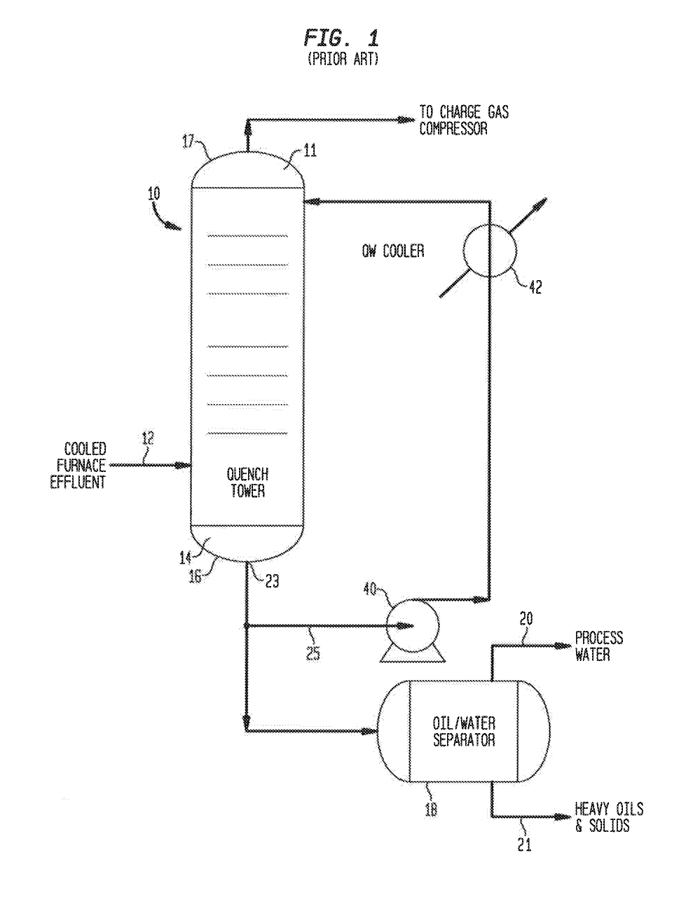

FIG. 2 shows a perspective view of a known hydrocyclone; and

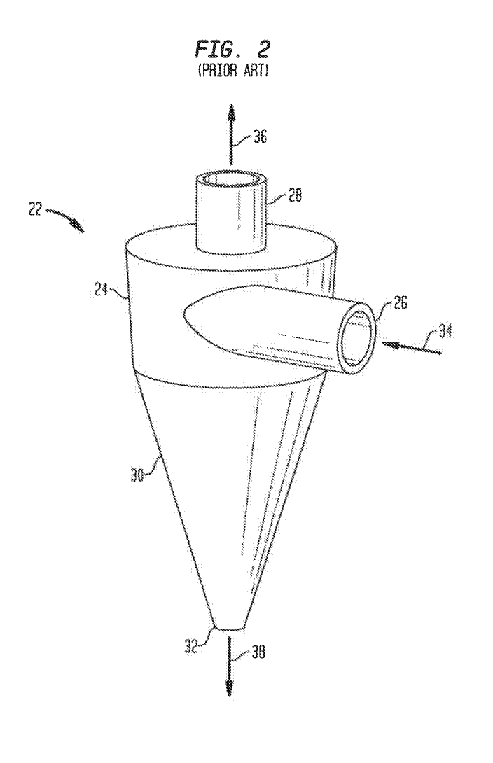

FIG. 3 shows a schematic of a quench water hydrocyclone apparatus and system embodiment according to the present invention.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

As used herein, the term “ullage” refers to an amount of a tank or container not being full.

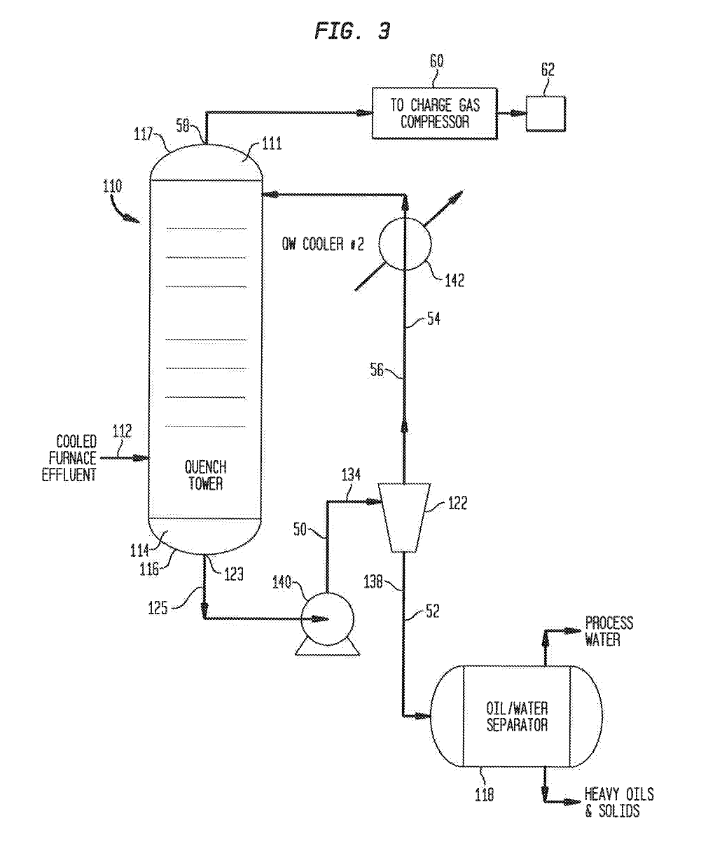

Referring to FIG. 3, and in general, the total “bottoms” or the liquids 114 from the quench water tower 110, which include quench water, process water, heavy oils and solids, are delivered from an outlet 123 of the tower into a pipe 125 in fluid communication with a pump 140 and through a line 134 to the hydrocyclone 122 by a pump 140. The quench water tower resembles a tank or a vessel. The stream 50 moving through the line 134 contains the quench water, the process water and all heavy oils and solids, and is separated by centrifugal force in the hydrocyclone 122. The heavy stream 138 leaving an outlet of the hydrocyclone 122 contains all the process water, all heavy oils and solids, and is sent through a line 52 to the oil/water separator 118. The remaining water from the hydrocyclone 122 is the quench water, which is now free of heavy oils and solids and can therefore be recirculated through a line 56 as a quench water stream 54 to the heat exchanger 142 and thereafter to the quench water tower 110. The embodiment of FIG. 3 can be used for example in an ethane-cracking ethylene plant.

Separation of the liquid stream 50 in the hydrocyclone 122 into particulate and liquid constituents results in a particulate laden heavy stream 138 directed in the line 52 to the oil-water separator 118 from an outlet of the hydrocyclone, and the quench water stream 54 which is directed through a line 56 to the heat exchanger 142 and quench water tower 110.

At least one and in certain applications a plurality of quench water heat exchangers 142 or coolers coact with the line 56 to cool the quench water from the hydrocyclone 122 before the quench water is fed into the tower 110.

Cooled furnace(s) gases in the ullage space 111, which now have a reduced water content and are without solids and heavy hydrocarbons, are removed or exhausted from the upper portion of the column through a nozzle 58, for example. The gases from the ullage space 111 are delivered to a charge gas compressor 60 and then to an ethylene plant 62 for further processing.

The present embodiments can be applied to quench water towers that use multiple quench water loops. The hydrocyclones can serve to concentrate the heavy oils into the hotter sections of the loops to avoid fouling cooling exchangers.

Some gas crackers use either a separate vessel or the lowest section of the quench water tower 110 to saturate the incoming furnace effluent with water. The water used in these systems is separate from the quench water used to cool the furnace effluent. A large portion of the circulating water from the saturator is vaporized by the furnace effluent and is condensed by the circulating quench water. In these plants, a hydrocyclone could be used on the quench water. The hydrocyclone would remove heavy oils and solids from the quench water and return same, along with the condensed water from the saturator, to the saturator system. This would prevent fouling of quench water cooling exchangers.

While the quench water hydrocyclone 122 can be used in new constructions, it has advantages for use as a retrofit to an existing plant. For example, the process water effluent from the hydrocyclone can be sent to an oil/water separator 118 which is disposed at a remote location from the quench water tower. Most conventional plants place the oil/water separator next to the quench water tower so the separator can be fed by gravity.

The integration of a cyclone improves significantly the quench water quality because i) the quench water can be cooled without concern that the heavy oils will solidify and foul the exchangers, ii) the oil content is significantly reduced in the quench water bottoms, which reduces the possibility of fouling of the quench water tower bottoms, and iii) solids are voided which would otherwise foul the quench water coolers and the quench water tower.

It will be understood that the embodiments described herein are merely exemplary, and that a person skilled in the art may make variations and modifications without departing from the spirit and scope of the invention. All such variations and modifications are intended to be included within the scope of the invention as described herein and defined in the appended claims. It should be understood that the embodiments described above are not only in the alternative, but can be combined.

What is claimed is:

1. A system for processing liquid from a quench water tower, comprising:
a quench water tower;
a first pipe for removing the liquid from the quench water tower;
a hydrocyclone in fluid communication with the first pipe and in which the liquid is separated into particulate and liquid constituents by centrifugal force; and
an oil-water separator downstream of and in fluid communication with a first outlet of the hydrocyclone.

2. The system of claim 1, further comprising a second pipe in fluid communication with a second outlet of the hydrocyclone and an inlet of the quench water tower through which the liquid constituent is returned to said quench water tower.

3. The system of claim 2, further comprising at least one cooling apparatus coacting with the second pipe for cooling the liquid constituent passing through said second pipe.

4. The system of claim 1, further comprising a pump in fluid communication with the first pipe for moving the liquid from the quench water tower through the first pipe to the hydrocyclone.

5. The system of claim 1, further comprising a third pipe in fluid communication with the oil-water separator for removing process water therefore.

6. The system of claim 5, further comprising a fourth pipe in fluid communication with the oil-water separator for removing heavy oil therefrom.

7. An apparatus downstream of and for processing liquid from a quench water tower, comprising:
a first pipe for removing the liquid from the quench water tower;
a hydrocyclone in fluid communication with the first pipe and in which the liquid is separated into particulate and liquid constituents by centrifugal force; and
an oil-water separator downstream of and in fluid communication with a first outlet of the hydrocyclone.

8. A method of processing liquid from a quench water tower, comprising:
removing the liquid from the quench water tower;
exerting a centrifugal force on the liquid with a hydrocyclone for separating said liquid into particulate and liquid constituents; and
further separating the particulate and liquid constituents downstream of the exerting centrifugal force.

9. The method of claim 8, further comprising returning the liquid constituent to the quench water tower, and directing the particular constituent to the further separating.

10. The method of claim 8, wherein the liquid comprises a waste stream from a chemical processing plant.

11. The method of claim 8, wherein the liquid comprises a waste stream from an ethylene plant.

12. The method of claim 8, further comprising venting any gas from an ullage above the liquid in said quench water tower and from said ullage for subsequent processing.
